(19) United States
(12) Patent Application Publication
(10) Pub. No.: US 2007/0201228 A1
(43) Pub. Date: Aug. 30, 2007

(54) Post Lantern Energy Conversion Device

(76) Inventor: Mark Young, Anderson, IN (US)

Correspondence Address: CHARM-LITE, INC., 2448 E. 39TH ST., ANDERSON, IN, 46013, US

(21) Appl. No.: 11/679,259

(22) Filed: Feb. 27, 2007

Related U.S. Application Data
(60) Provisional application No. 60/767,040, filed on Feb. 27, 2006.

(51) Int. Cl. F21V 14/00

(52) U.S. Cl. 362/255

(57) ABSTRACT

Device and wiring system of present invention allows for conversion of natural gas powered and 110 voltage post lantern lights to 12-volt or 24 volt electric energy by utilizing a copper bulb housing, attached to a CPVC stem, being hollow, wherein two center contact wires extend from stem, a third center contact wire being soldered to a copper ring, fitting into bulb housing sleeve groove. The soldered center contact wire being utilized for 12 volt wiring, and ignored for 24 volt wiring. Device wires are wired to separate center contact wires extending within post lantern pole, across residential lawns, to a transformer, plugging into a residential power line. Device replaces previous gas or 110 electric fixture components with utilization of inverted bulb device and invention's wiring procedure, comprising copper ring soldered to center contract wire for 12 volt, and ignoring soldered wire for 24 volts.

### CROSS-REFERENCE TO RELATED APPLICATIONS

This application claims priority to a provisional patent application which has been assigned U.S. Ser. No. 60/767040, filed Feb. 27, 2006, filed by the inventor and titled “Post Lantern Energy Conversion Device.”

### SEQUENCE LISTING OR PROGRAM

U.S. Pat. No. 4,835,748;
U.S. Pat. No. 4,577,265;
U.S. Pat. No. 4,616,299 to Krause
U.S. Pat. No. 5,398,180 to Lee
U.S. Pat. No. D461921S to Ellis
U.S. Pat. No. 4,785,384 to Swald

### BACKGROUND OF THE INVENTION-FIELD OF INVENTION

The present invention relates to a retrofit device and post lantern electric wiring system, particularly in relation to a device and conversion wiring system used to convert natural gas burning lanterns to electric, or to convert high voltage electric to low voltage lighting. The present invention also relates to energy conservation, cost efficiency, increased safety, a post lantern 12-volt wiring system, and incandescent or LED simulation of gas lighting.

### A. BACKGROUND OF THE INVENTION

Post lantern lighting is a type of exterior lighting, commonly on the top of a metal pole, used for night and sometimes day lighting for both safety and decorative purposes. Post lantern lighting is historically known as gas lighting, gas being the original energy source for post lantern illumination. Gas was commonly utilized as the primary source of illumination, with gaslights existing both interior and exterior during that era. As electric energy became much more efficient as a source of illumination, efforts to replace gas illumination with electric lighting were pursued, however, the last twenty years have presented renewed interest in residential exterior natural gas lighting, with historical and modern residential gas burning lights existing across the United States and internationally.

The recent gas crisis, however, has given rise to renewed interest in energy conservation and cost efficiency, leading to increased awareness in alternative methods of power.

### B. INTRODUCTION OF PROBLEMS ADDRESSED

Though post-lantern, electrical gas light fixtures have been available in the lighting market, they are primarily 110 volts, as referenced in U.S. Pat. No. 4,835,748, U.S. Pat. No. 4,577,265, and U.S. Pat. No. 4,616,299 to Krause. Such lighting utilizes a single bulb, and was meant to replace existing electric lighting fixtures, more closely simulating the glow of gas lighting, rather than serve as a means of converting gas power. These inventions utilize only one 110-volt bulb, whereas traditional gas lighting more commonly results from two mantles.

Other available products, include high pressure, solar powered, fluorescent or reflective technologies as alternatives to gas powered luminaries. Solar powered lighting, as well as many reflective technologies are more compatible with small terrain, pathway, or garden lighting, in which a small lantern hangs from a four pronged metal rod or is connected to the ground by a stake as referenced in U.S. Pat. No. 5,398,180, Lee, and U.S. Pat. No. 461921, Ellis.

Reflective lighting in post lantern mantle technologies, however, does exist. Such inventions attempt to simulate the glow of gas lighting, rather than serving as a means of electrical conversion. Florescent and solar power in post lantern lighting also exists, but does not adequately resemble gas lighting, as illumination is bright white, and does not resemble the glow of gas lighting. Fixtures often are for a single bulb, and were designed as alternative lighting, and not necessarily with post lantern conversion in mind. Florescent lighting is also not a reasonable alternative to gas lighting due to incident of failure in subfreezing climate zones.

Two-mantled gaslight fixtures have existed for some time in the marketplace, but are restricted to the Internet and therefore not available to a mass market. The primary purpose of these products is conversion of post lantern gaslights to electric power, but they are not available or convertible to 12 volts. Products are also inferior, containing a high ratio of plastic, with a small amount of aluminum. Plastic utilized in heat sensitive areas, such as within housing bulb sockets melt and deform over time, when bulb heat increases. Such products generally offer a two-year life span, at which time internal components corrode, crack, melt, and plastic disassembles from housing, resulting in replacement. Most products are offered at 110 voltages, which often represent safety issues, including incident of shock, short circuiting of conversion devices, power surges traveling from post lantern wires to main residential power lines during electrical storms, and short circuiting of interior appliances.

Homeowners attempting to simulate the gaslight look encounter problems in the marketplace when converting gas burning post lanterns to electric light since fixtures available on the mass market are single-sockets, adaptable to a single, incandescent or solar light bulb at the bottom of the lamp-head. Problems with condensation surrounding the bulb socket exist, which leads to deterioration of sockets, short circuiting and product replacement.

Lamp-heads for gas burning post lanterns are not always adaptable to electric conversion. Upright bulb sockets collect moisture within sockets, presenting increased opportunity for short circuiting, socket deterioration, increased safety hazard and incident of electrocution and consumer fatality, therefore gas lamp-heads are not adaptable to 110 electrical use. Approved lamp-heads for 110 v electrical use are necessary for consumer safety. This increases both expense and time when converting natural gas burning lamps to electric. State laws generally require when dealing with 110 volts certified electricians must install products, leading to even more expense for the consumer.

Consumers when relying on available post lantern fixtures in hardware and department stores to convert gaslights are restricted to upright, single socket fixtures. Screw-in bulbs are then utilized with a bulb socket at 110, 24 and 12 volts, but do not simulate retro-fit or glow of traditional gas-lighting. The only options presently available to consumers attempting to simulate gas-lighting are specialty screw-in bulbs, such as referenced in U.S. Pat. No. 4,785,384, Swald. These, however, do not adequately resemble or simulate the overall experience of traditional gas lighting.

Many gaslight owners, due to rising expenses of natural gas are shutting off use of post lantern lights. With rising gas costs a single post lantern, natural gas burning light costs hundreds of dollars a year to operate. Shutting off use, however, sometimes presents safety and lighting issues to communities, particularly for those whose gas lights serve as street-lighting. Many housing associations now require homeowners with gas burning yard lights to convert to electric due to rising costs, as well as safety concerns. Community aesthetics and historical culture are a concern and are often lost when post lantern heads and fixtures must be replaced in order to convert gaslights to electric. Antique lamp-heads are often worth hundreds, sometimes thousands of dollars, and may have existed in communities for over a hundred years. Expanding budgets for individual homeowners, housing associations and city governments, attempting to provide adequate residential and city street-lighting presents significant financial set-backs for those still utilizing natural gas. No product presently exists in the marketplace which adequately addresses both financial and aesthetic concerns.

### SUMMARY OF THE INVENTION

The present invention relates to a retrofit device and post lantern electric wiring system The present invention comprises a post lantern retrofit-12 volt device and electric wiring system, conversion device for post lantern gaslights and high voltage wiring systems. Conversion is achieved by replacement of gas emitting components with 12 volt wiring, bulb tree illumination device for natural gas burning lights. Conversion of high voltage wiring systems is achieved with post lantern electrical 12-volt wiring, bulb tree illumination device system. Conversion occurs by use of post lantern device, replacing prior lamp components, and by parallel wiring of device to center contact wires, also wired to a 12 volt power source. Illumination occurs when single contact bayonet bulbs are placed in bulb sockets, and power supply is plugged into main residential power line.

Invention is adaptable to 24-volt systems by ignoring center contact wire soldered to ring of copper bulb socket housing, and series wiring the device to center contact wires.

The invention converts natural power source from gas energy to electric through conversion device and wiring system. It may also be utilized to convert high voltage post lanterns to low voltage through conversion device and wiring system. Power source is derived from an associating transformer. Transformer plugs into residential power line. Light source is illuminated by use of single bayonet bulbs, and optional dusk to dawn photo-sensors that detect ambient light, causing automatic illumination at sunset, and automatically shutting off at dawn.

In accordance with the invention, bulb tree illumination device comprises a copper, with inverted bulb sockets, spring wired, with a center contact spacer allowing for attachment of bulbs at each bulb socket. Copper housing being connected to a stem sleeve, a CPVC tube, which extends from copper stem sleeve, being hollow, having an opening at the bottom, where center contact wires extend through and beneath stem for further wiring directly above post lantern pole. Center contact wires at each side of bulb socket having a bulb socket spring and fiberglass center contact spacer assembled above bulb placement. A third center contact wire being soldered to copper ring, fitting into copper stem sleeve groove for parallel wiring. Post Lantern Conversion device center contact wires being wired parallel or series wired to separate center contact wires, dependant on wiring system preferred. Center contact wires extending within pole, being placed within ground of residential lawns, to extend to power source. Center contact wires being wired to power source, power source being plugged to main residential power connection, bulbs being placed on both right and left sides of bulb sockets.

### OBJECTS AND ADVANTAGES

The current invention utilizes copper housing, coupled with a 12-volt wiring system, which is safer, energy conserving, cost efficient and completely eliminates device replacement. The system utilizes parallel wiring, rather than more common series wiring, adapting to existing 12-volt transformers, and energy saving dusk to dawn controls currently offered in the market. By utilization of a copper housing the current invention also prevents corrosion of internal and external components, as well as prevention of cracking, melting and housing disengagement. The system utilizes inverted bulb sockets, which repel moisture, prevent short-circuiting, reduce socket deterioration, and duplicate the traditional two mantle gas-light. The invention also utilizes a 12-volt wiring system, with an extra wire soldered to a copper ring, which connects to a copper housing stem sleeve groove for parallel wiring, to be used in correlation with a 12-volt transformer and dusk to dawn system, preventing excessive heat in bulb sockets. The invention easily works in correlation with 12-volt systems, in which one transformer is utilized for multiple devices.

The existing invention is also convertible to 24 volt wiring systems and transformers, in which the middle soldered wire is ignored, and regular, series wiring is conducted, making the post lantern energy conversion device adaptable to 24-volt systems.

The system is not restricted to gas light conversions, but may also be utilized to convert 110-volt post lantern wiring systems to 12-volt, increasing safety, reducing incident of shock and short-circuiting. It may also be utilized to replace an existing one-bulb fixture system with the current invention's two-mantle fixture, more closely simulating gas lighting.

The system may be used in existing lamp heads to convert from gas energy to electric, to convert high voltage electric to low voltage, therein saving consumers time and money, reducing community city and government budgets, as well as preserving community aesthetics, historical culture and relevance. The system may also be used in new post lantern systems to maintain cultural relevance with increased safety.

Bulb sockets of device are adaptable to any single contact bayonet bulb, which includes incandescent and longer lasting LED bulbs. Because the device utilizes single contact bulbs, device is adaptable to both incandescent and LED bulbs, without purchase of specialty lamp heads.

Currently, the only 12-volt exterior wiring systems available on the market are small, walk-way style lights, small, decorative garden terrain lights, connected to the ground by a stake, and 12 volt single bulb fixtures that connect to post lantern heads in an upright position at the bottom of the head. Broadly considering the market as a whole, post lantern lighting is generally offered at 110 volts with upright single bulbs, and presents increased hazard and liability when compared with the safer Post Lantern Energy Conversion Device, in which a 12-volt retrofit device and post lantern electric wiring and illumination system is utilized.

### BRIEF DESCRIPTION OF DRAWINGS

Advantages of the present invention will be apparent from the written description and the drawings which:

FIG. 1—Full view of a post-lantern, low-voltage energy conversion fixture and illumination device in accordance with the present invention.

FIG. 2—Full view of a post lantern, low voltage energy conversion fixture, within an associating lamp head, shown in accordance with invention in upright position, having been wired to lamp head base.

FIG. 3—Electrical wiring schematic of post-lantern, low-voltage energy conversion parallel wiring system in accordance with invention, and an electrical wiring schematic of post-lantern, low voltage energy conversion fixture for a series wiring system.

### DESCRIPTION OF THE DRAWINGS—REFERENCE NUMERALS

The following list refers to the drawings:

31 solder joint for ground conductor and copper joints

32 copper bulb housing

33 CPVC copper union

34 center contact ring

35 spun copper socket

36 CPVC copper stem

37 bulb socket springs

38 fiber glass insulator with brass nib connected to center conductor wire

39 single contact bayonet bulbs

40 center contact wire (right side)

41 ground wire

42 center contact wire (left side)

43 half inch flat nut

44 1 3/25 fender washer

45 1 3/25 quarter inch IP threaded nipple

46 lamphead

47 lamphead base

48 lamphead pole

A Electrical wiring schematic of post-lantern, low-voltage energy parallel wiring system

49 12 volt wiring system

B Electrical wiring schematic of post-lantern, low-voltage energy series wiring system

50 24 volt wiring system

### DESCRIPTION OF PREFERRED EMBODIMENT

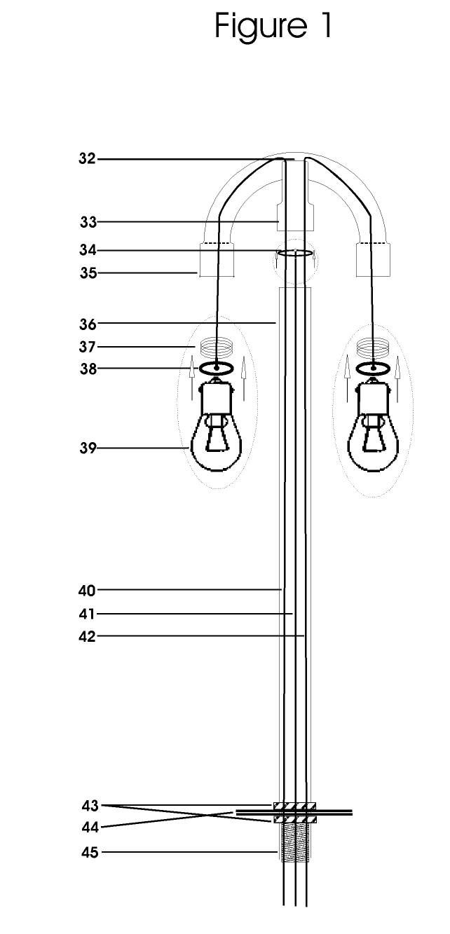

Referring to drawings, and especially that of FIG. 1, the post latern, low voltage energy conversion fixture and wiring system is illustrated having a copper housing, 32, connected to copper stem sleeve solder joint 31, having bulb sockets 35, a hollow copper stem, 36, connected to bulb socket stem sleeve, having a center contact parallel wire lead 41, soldered to copper ring 34, having two center contact wires 40, 42, a fiberglass spring 37, a center contact spacer 38, two single contact bayonet bulbs 39, a flat nut, 43, a fender washer, 44, and a threaded nipple, 45.

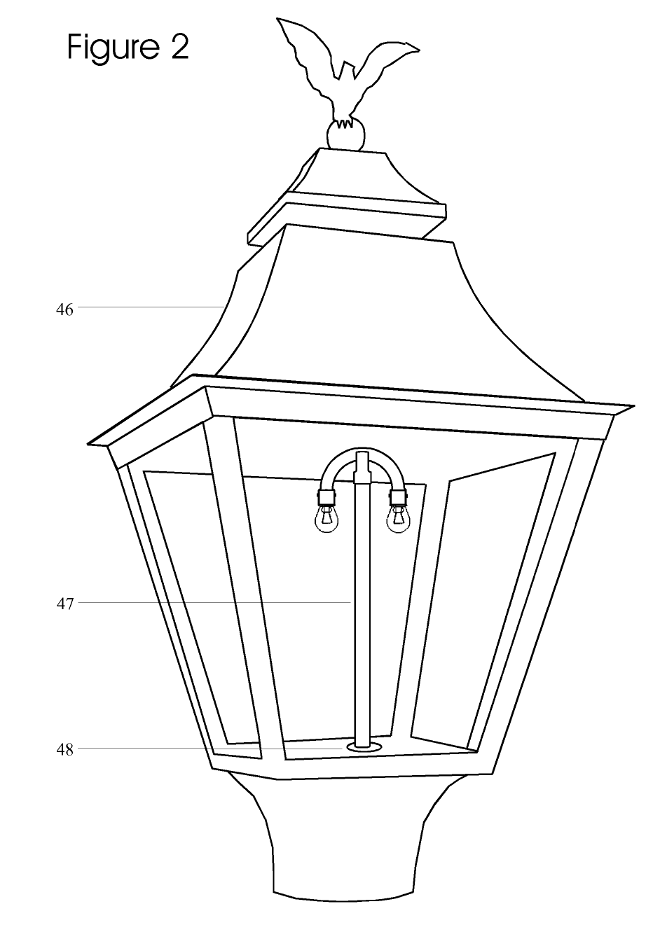

FIG. 2 illustrates the full view post lantern, low voltage energy conversion device 47 within an associating lamp head 46, after removal of post lantern gas emitting components from lamp head base 48.

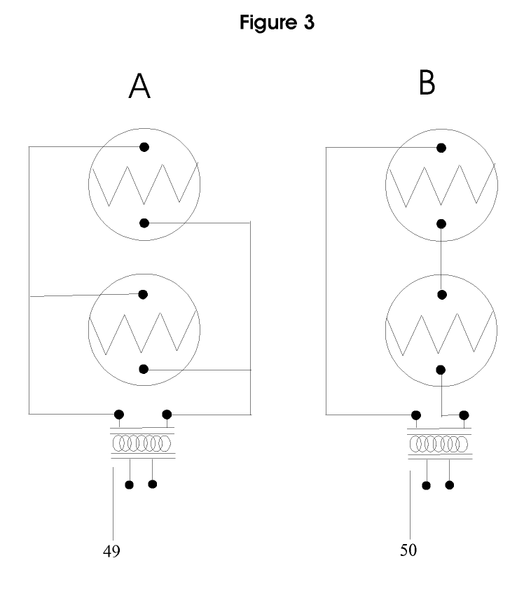

FIG. 3 illustrates an electrical wiring schematic of post-lantern, low-voltage energy conversion parallel wiring system method A, showing an associating 12-volt transformer 49, and series wiring B, showing an associating 24 volt transformer 50.

Thus, in operation, the post lantern 12 volt energy conversion wiring system illustrated in FIG. 1, 34, is attached to center contact wires 40, 42, which act as one wire, and are parallel wired. Lead 41 is wired to center contact wires and buried within the earth, extending and wired to power source, plugging into residential outlet, as best shown in FIG. 3, A 49. As illustrated in FIG. 1, in parallel wiring, 40 and 42 are wired to center contact wire lead 41. Wire lead 41 is ignored in series wiring.

The post lantern wiring and illumination device in accordance with the invention are illustrated in FIG. 3 for use in converting natural gas burning lights to 12 or 24 volt power. Illumination is illustrated in FIG. 1, wherein bulbs 39 plug into copper housing sockets 35.

Replacement of gas emitting components is best illustrated in FIG. 2, in which post lantern low voltage energy conversion device 47 is attached to lamp base 48 by use of attachments best illustrated in FIG. 1, wherein flat nut 43, and washer, 44 are assembled onto threaded nipple 45, which extends from copper stem 36, therein replacing gas components. Post lantern low voltage energy conversion device, as illustrated in FIG. 2, 47 is attached to lamp base 45 by use of wiring system in FIG. 3, wherein A, being parallel wired, plugs into transformer 49, resulting in 12 volt energy. B, being series wired, plugs into transformer 50, resulting in 24 volt energy.

It should be clear at this time that the present invention provides a means of converting post lantern natural gas burning lights to low voltage electric power through the post lantern device and wiring system, with the center contact parallel wire lead soldered to a copper ring, which fits into copper groove, into copper sleeve groove, for exclusive use in 12 volt wiring, wired to center contact wires, extending within post lantern pole, extending across residential lawns and then wired to a single 12 volt transformer, or a transformer utilized for several electric devices, which is then plugged into a residential main power source. The post lantern conversion device illuminates bulbs by single contact bayonet bulb placement in inverted copper housing sockets.

It should also be clear that the post lantern low voltage, conversion and wiring device is adaptable to 24 volts dependant upon series wiring, in which center contact parallel wire soldered to copper ring is ignored in wiring process. It then extends through wire pole, across lawns and is wired to a single 24 volt transformer, then plugged into a residential main power source.

It should also be clearly recognized that due to present and projected energy costs, the present invention incorporates a safer, energy efficient, alternative source of energy, which may also be utilized in correlation with dusk to dawn systems. By utilizing single bayonet bulbs, which include incandescent or LED bulbs, coupled with a two-mantle device, the invention simulates gas lighting, while providing a means of converting post lantern gas luminaries to electric. The invention also allows for conversion of 110 voltage electric to safer, low voltage electric, thereby reducing short circuiting and possible fatalities. The present invention's inverted copper housing bulb sockets, coupled with copper bulb sockets, increase life of device, prevent internal component corrosion and displacement of device, completely eliminating device replacement.

What we claim is:

1. A post-lantern 12 volt wiring system, illumination, and conversion device comprising:
(a) a copper housing bulb socket; in an inverted shape, having a left and right bulb socket; preventing displacement and stray light pollution, protecting fixture against external element corrosion, short circuiting; as well as said copper housing bulb socket acting as a conductor of heat and electricity between bulb sockets;
(b) a CPVC plastic or copper stem, attached to center of said bulb socket fixture; acting as nonconductor of electricity; preventing electrical shorts in post lantern mantle and pole;
(c) a center contact, plastic coated, common conductor wire, soldered to joint in said copper housing bulb socket fixture, for use in 12-volt parallel wiring;
(d) two center contact wires, wired separately, through right side and lift side of said bulb sockets, through said plastic stem, utilized in 12-volt parallel wiring or 24-volt series wiring, utilized in correlation with 12 or 24-volt isolated power source systems;
(e) a bulb socket spring and fiberglass center contact spacer assembled at end of said center contact wires, allowing for attachment of single contact bayonet bulbs, the fiberglass also acting as nonconductive material in restricting electricity shorts;
(f) said fiberglass center contact spacer having a brass nib, which contacts with bulb center nib, causing electrical current into bulb filaments, and post lantern illumination.

2. A post lantern illumination device and 12 volt wiring system in accordance with claim 1 in which the post-lantern energy source is converted from gas energy to electric energy.

3. A post lantern illumination device in accordance with claim 2 which replaces gas-emitting internal components with post lantern illumination device and conversion wiring system.

4. A post lantern illumination device and energy conversion wiring system in accordance with claim 3 which converts natural gas energy to an electric power source causing reduction of energy output, increasing energy conservation.

5. A post lantern wiring device, illumination, and energy conversion device in accordance with claim 3 in which the post-lantern conversion of gas energy, utilizing 12 or 24-volt power sources, conserves energy output by plugging transformer into main residential power source, converting high voltage electric to low-voltage energy.

6. A post lantern wiring device, illumination, and energy conversion device in accordance with claim 4 further provides energy conservation when used in correlation with alternating or direct current low voltage dusk to dawn systems, in which dusk to dawn sensors regulate electricity usage, dependent on exterior quantity of ambient light.

7. A post lantern wiring device, illumination, and energy conversion device in accordance with claim 2 in which a post-lantern wiring device is fitted inside the post lantern for electrical illumination of post lantern through usage of single contact bayonet bulbs, with center contact wires extending beneath said copper stem of post lantern wiring fixture.

8. A post lantern wiring fixture, illumination and energy conversion device in accordance with claim 7 in which a post-lantern wiring device is fitted inside the post lantern for electrical illumination of post lantern through usage of single contact bayonet bulbs, to include single contact bayonet LED bulbs, which extend bulb life and provide additional energy conservation.

9. A post lantern wiring device, illumination and energy conversion device in accordance with claim 4 providing substantial residential and industrial savings when converting from natural gas burning post lantern lights to electric energy, particularly when used in correlation with dusk to dawn systems and energy saving bulbs.

10. A post-lantern wiring device, illumination, and energy conversion device in accordance with claim 6 in which post-lantern wiring fixture's center contact wires extend inside post lantern pole, across residential lawns, and are wired to said conversion power source.

11. A post lantern wiring device, illumination and energy conversion device in accordance with claim 9 in which said center contact wires are wired to lead wire, creating parallel wiring, extend inside post lantern pole, across residential lawns and are plugged into 12 volt power source, or transformer operating several 12 volt devices.

12. A post lantern wiring device, illumination and energy conversion device in accordance with claim 9 in which wire lead is ignored and center contact wires are series wired within wiring device for 24 volt, extending within lantern pole, across residential lawns and are plugged into a 24 volt power source.

13. A post lantern wiring device, illumination, and energy conversion device in accordance with claim 1 in which post lantern wiring fixture provides increased safety by converting 110 electric post lantern wiring systems to low voltage energy.

14. A post lantern-wiring device, illumination, and energy conversion device in accordance with claim 1 in which the use of copper housing bulb socket increases the life of the fixture, prevents corrosion, melting, and cracking.

15. A post-lantern wiring device, illumination and energy conversion device in accordance with claim 10 provides further prevention of corrosion by said copper bulb housing sockets being mounted to CPVC or copper stem.

16. A post-lantern wiring device, illumination and energy conversion device in accordance with claim 11 provides further prevention of corrosion and prevents short circuit in said copper bulb housing socket due to inverted shape allowing the flow of condensation away from bulb nib.

17. A post lantern wiring device, illumination and energy conversion device in accordance with claim 1 in which engineering of said copper bulb housing, coupled with gravitational forces of moisture being pulled away from bulb nib, rather than toward it, prevents low voltage short-circuiting.

18. A post lantern-wiring device, illumination and energy conversion device in accordance with claim 1 in which the use of said copper housing bulb socket mounted on CPVC or copper stem, elevated inside lamp-head, shields ambient light from straying into atmosphere, decreasing light pollution from said light source.
